(19) United States
(12) Patent Application Publication
(10) Pub. No.: US 2008/0306831 A1
(43) Pub. Date: Dec. 11, 2008

(54) Systems and methods for facilitating purchase transactions in a network

(76) Inventor: Jack Phillip Abraham, Great Falls, VA (US)

Correspondence Address: Jack P. Abraham, 246 Hawthorne Avenue, Palo Alto, CA, 94301, US

(21) Appl. No.: 11/806,989

(22) Filed: Jun. 5, 2007

(51) Int. Cl. G06Q 30/00; G06Q 90/00

(52) U.S. Cl. 705/26

(57) ABSTRACT

Systems and methods for facilitating the purchase of one or more items from one or more vendors on a network through a platform. In one embodiment of the present invention, a method includes receiving at the platform a request from a user for purchase of at least one item from at least one vendor, and transmitting, from the platform, instructions to create a user account at each vendor from whom a purchase is made. An indication is transmitted, from the platform, to each vendor to purchase at least one item through the corresponding user account. The platform receives a corresponding confirmation associated with the user account at each vendor.

### BACKGROUND OF EMBODIMENTS OF THE INVENTION

### Field of Embodiments of the Invention

Embodiments of the present invention generally relate to facilitating purchase transactions in a network(s) and, more particularly, to systems and methods for facilitating purchases from one or more vendors on a network(s) on behalf of a customer.

One of the challenges associated with making the Internet accessible and useful has been making its content readily available to its users. At its inception, the World Wide Web (“WWW” or “web”) included a series of disaggregated, static, and unsearchable web pages. Before a user could access a webpage, he or she had to know the uniform resource locator (URL) of a particular website in order to load the webpage. Initially, the web did not allow users to view desired content from across the web in one place. Search engines were one of the first systems built to address this problem. By enabling web users to query an index of all known web pages, users were able to obtain relevant and useful content with greater ease and speed.

Users of the Internet also encountered challenges when attempting to purchase goods online. Online retailers generally utilized different web pages, presenting users with the same or similar products having, for example, different selling parameters such as selling price, availability, shipping costs and/or delivery date. The user (e.g., a customer), accordingly, was not readily able to locate all web pages in which a product was listed, and compare them to find the combination of selling parameters preferred by the user. Shopping comparison engines addressed this challenge by enabling web users to view in a consolidated manner the selling prices of various products offered by various online retailers. Examples of such online comparison shopping websites include: www.shopzilla.com, www.shopping.com and www.pricegrabber.com.

Some known online comparison shopping engines calculate a “final price” that includes tax and shipping cost. For example, U.S. Pat. No. 7,120,595, entitled Method and System for Providing Online Comparison Shopping, allows users to find the lowest total price for set of goods, factoring in shipping and taxes.

Other features that facilitate online transactions are also known. For example, U.S. Pat. No. 6,642,624, entitled Method and System for Integrating Transaction Mechanisms Over Multiple Internet Sites, describes a system that uses form fillers to automatically fill out transaction forms to allow customers to purchase a plurality of products from a plurality of vendors. U.S. Pat. No. 6,882,981, entitled Method and System for Integrating Transaction Mechanisms Over Multiple Internet Sites, describes a system allowing users to select a plurality of products mapped to a plurality of merchants from a virtual site with a single interface.

However, I have discovered that systems that are used to facilitate online shopping require users to establish a new account at the vendor to complete a purchase if they do not already have one. This is a difficult and time consuming process, requiring substantial input from the user. Users may also be reluctant to establish a separate account for each vendor for fear of compromising personal information, such as credit card information.

In addition, in known online shopping systems, when a customer uses a shopping comparison engine to purchase multiple products from multiple vendors, customers must keep track of product, shipping, and customer service information/policies of each vendor from which a purchase is made. In addition, customers must separately track their account information at each account with the vendor, as well as track transaction-related information separately at each vendor for assurance of completion of transactions undertaken with multiple vendors. These processes are tedious and can prove to be frustrating to customers, particularly during the course of purchasing multiple products.

### SUMMARY OF EMBODIMENTS OF THE INVENTION

Embodiments of the present invention are generally directed to facilitating and streamlining the online shopping experience. In one embodiment of the present invention, a method includes receiving at the platform a request from a user for purchase of at least one item from at least one vendor. Instructions are transmitted from the platform to create a user account at each of the at least one vendors. An indication is transmitted from the platform, to one or more vendors, to purchase at least one item through the corresponding user accounts. The platform receives a corresponding confirmation associated with each user account from each of the one or more vendors.

The method can also include receiving account update information from the user, updating the platform account for the user based on the account update information, and transmitting corresponding user account update instructions to the vendors. In addition, each corresponding confirmation can be received at a corresponding e-mail account associated with each corresponding user account. Each corresponding e-mail account can be created in response to receiving the request from the user for purchase of at least one item from each of the vendors. A platform confirmation e-mail message can be transmitted to an operational e-mail address of the user. The platform confirmation e-mail can be based on the corresponding confirmation from each of the vendors.

In another embodiment of the present invention, a method for facilitating the purchase of items from multiple vendors on a network includes receiving a request from a user for purchase of a first item from a first vendor, and a second item from a second vendor. A first instruction is transmitted to create a first user account at the first vendor, and a second instruction is transmitted to create a second user account at the second vendor. A first purchase indication is transmitted to the first vendor for purchase of the first item through the first user account, and a second purchase indication is transmitted to the second vendor for purchase of the second item through the second user account. A first purchase confirmation is received from the first vendor, and a second purchase confirmation is received from the second vendor.

The method can also include receiving account update information from the user, updating the platform account for the user based on the account update information, transmitting a first update instruction based on the account update information to the first vendor, and transmitting a second update instruction based on the account update information to the second vendor. The first instruction may include a first proxy e-mail address associated with the platform account for the user, and the second instruction may include a second proxy e-mail address associated with the platform account for the user. The platform account associates an operational e-mail address with the user, and the platform can transmit a confirmation e-mail message, based on the first confirmation and the second confirmation, to the operational e-mail address.

In still another embodiment of the present invention, a system is provided for facilitating the purchase of items from multiple vendors on a network. The system includes a computing device for receiving a request from a user for purchase of a first item from a first vendor and a second item from a second vendor. The computing device transmits a first instruction to create a first user account on behalf of the user at the first vendor, and transmits a second instruction to create a second user account on behalf of the user at the second vendor. The computing device also transmits a first purchase indication to the first vendor for purchase of the first item through the first user account, and transmits a second purchase indication to the second vendor for purchase of the second item through the second user account. In addition, the computing device receives a first confirmation from the first vendor and a second confirmation from the second vendor.

The computing device can also create a platform account for the user in response to a request received from the user. In addition, the computing device may receive account update information from the user, update the platform account for the user based on the account update information, transmit a first update instruction based on the account update information to the first vendor, and transmit a second update instruction based on the account update information to the second vendor. The platform account can associate an operational e-mail address with the user, and transmit a platform confirmation e-mail message, based on the first confirmation and the second confirmation, to the operational e-mail address.

In yet another embodiment of the present invention, a computer program product resides on a computer readable medium, for use in a computer network environment that facilitates the purchase of items from multiple vendors on a network, and includes instructions that cause and/or enable a computer to receive a request from a user for purchase of a first item from a first vendor, and a second item from a second vendor. Instructions are also provided that cause or enable the computer to transmit a first instruction to create a first user account at the first vendor, and transmit a second instruction to create a second user account at the second vendor. Additional instructions are provided that cause or enable a computer to transmit a first purchase indication to the first vendor for purchase of the first item through the first user account, and transmit a second purchase indication to the second vendor for purchase of the second item through the second user account. In addition, instructions are provided that cause or enable a computer to receive a first purchase confirmation from the first vendor, and receive a second purchase confirmation from the second vendor.

Additional instructions may be provided that cause or enable a computer to create a platform account for the user in response to a platform-account creation request received from the user. Further, instructions may be provided that cause or enable a computer to receive account update information from the user, update the platform account for the user based on the account update information, transmit a first update instruction based on the account update information to the first vendor, and transmit a second update instruction based on the account update information to the second vendor.

Additional instructions can be provided that cause or enable a computer to associate a first proxy e-mail address with the platform account for the user, and associate a second proxy e-mail address with the platform account for the user. Further instructions may be provided that cause or enable a computer to transmit a platform confirmation e-mail message, based on the first confirmation and the second confirmation, to the operational e-mail address.

### BRIEF DESCRIPTION OF THE DRAWINGS

FIG. 1 is an exemplary block diagram illustrating a network configuration between a computing device, platform, and vendors.

FIG. 2 is an exemplary flow diagram enabling a user to make a first time purchase of one or more items from one or more vendors.

FIG. 3 is an exemplary flow diagram enabling a user to make subsequent purchases of one or more items from one or more vendors.

FIG. 4 is an exemplary flow diagram for aggregating confirmation e-mails from one or more vendors into a single e-mail to be sent to the user.

FIGS. 5a and 5b, taken together, further illustrate aspects of the confirmation e-mail aggregation process.

FIG. 6 is an exemplary flow diagram enabling user account information to be automatically updated in the user's proxy account at one or more vendors.

FIG. 7 shows an exemplary computer-apparatus and storage-medium embodiment of the invention.

### DESCRIPTION OF EMBODIMENTS OF THE INVENTION

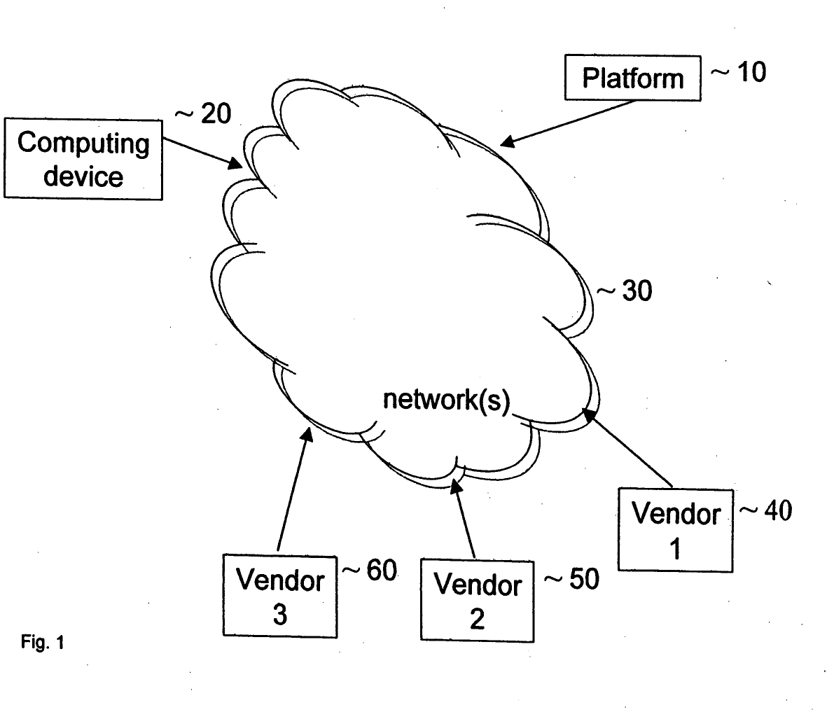

FIG. 1 is an exemplary block diagram illustrating a network configuration between a computing device, a platform, and one or more vendors. FIG. 1 shows platform 10, computing device 20, network(s) 30, vendor 40, vendor 50 and vendor 60. Although three venders 40, 50, 60 are shown in FIG. 1, any number of vendors may be present.

Platform 10 can be any computing device running software capable of implementing the functionality associated with platform 10 described herein. In one embodiment of the present invention, platform 10 can include a plurality of Power Edge™ Blade Servers, from Dell, Inc., Round Rock, Tex., running Linux server software. Every two to four Blade Servers can be operably connected to a Barracuda model 340 load balancer, from Barracuda Networks, Clearfield, Utah. The load balancer(s) can run software from The Foundry Software Development Company, St. Louis, Mo.

Computing device 20 can be, for example, any standard personal computer (PC), Macintosh/Apple computer, and/or laptop computer such as an IBM ThinkPad or MacBook from Apple Inc., through which a user (e.g., a customer) uses to communicate with other nodes located on network 30, such as vendor 40 and/or vendor 50. In addition, computing device 20 may also include web-capable handheld devices such as the Palm® Treo™ 650 smartphone. Computing device 20 is configured to display, in response to an end user (e.g., customer) query, information pertaining to product and price information for one or more items from one or more vendors 40, 50, 60. Such functionality is known in the art. For example, U.S. Pat. No. 7,082,426, entitled Content Aggregation Method and Apparatus for An On-line Product Catalog, which is herein incorporated by reference in its entirety, discloses and discusses a network system with such functionality.

Network 30 may be any or any combination of the Internet, local area network(s) (LANs), wide area network(s) (WLANs), virtual private networks (VPNs), fiber-optic, wireless, land-line, mobile phone and/or other networks. Vendors 40, 50, 60 can be any online retailers or sellers, such as www.bestbuy.com, www.amazon.com, www.target.com, and the like.

Proxy Account Creation in Connection with First-Time Purchases Through a Platform

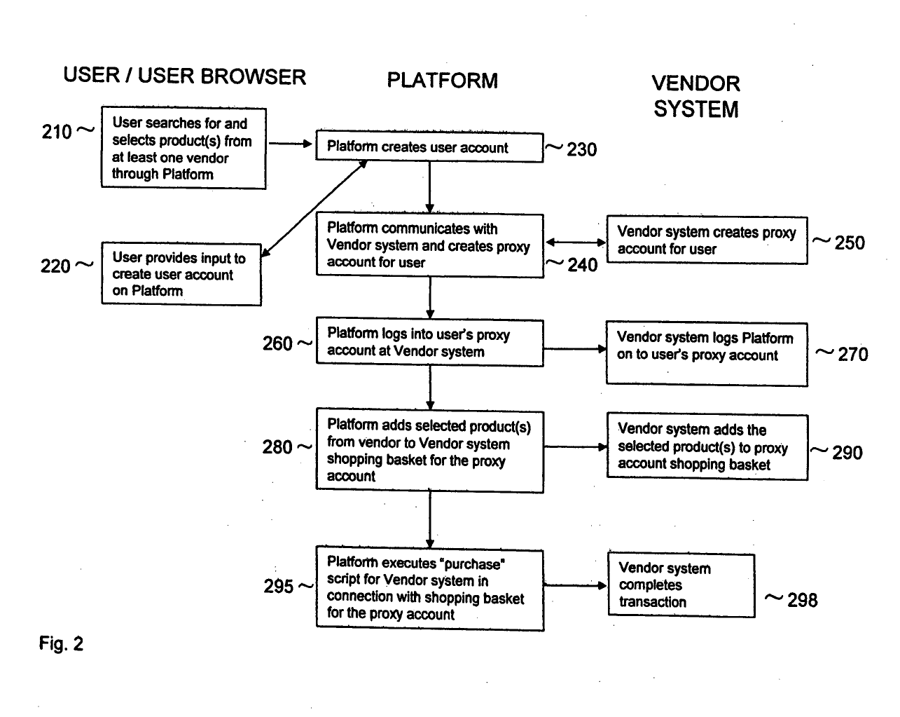

FIG. 2 is an exemplary flow diagram enabling a user (e.g., a customer) to make a first time purchase of one or more items from one or more vendors. As used herein, the terms “item” and “product” encompass both goods and services, as well as any combination thereof. At step 210, the user uses computing device 20 to search for one or more products at one or more vendors 40, 50, 60. The user may decide to purchase one or more of the products, from one or more vendor(s) 40, 50, 60, using platform 10 to facilitate such purchase(s). The user decides which item(s), from which vendor(s) 40, 50, 60, he/she would like to purchase, and proceeds to checkout in a standard manner (e.g., using a shopping cart). Before checking out, platform 10 prompts the user to create an account at platform 10, as is described in connection with steps 220 and 230.

At step 220, the user may utilize computing device 20 to respond to queries from platform 10 upon platform 10's determination that the user does not have an account established at platform 10. In creating a user account, computing device 20 may transmit information to platform 10, such as user-provided shipping and billing information, e-mail address and/or password information. Further user facilitated interaction between computing device 20 and platform 10 may occur, for example, because the user's desired username is taken, account details do not appear to be accurate, and/or to establish shipping preferences, login preferences, and/or other preferences. As used herein, an “operational e-mail address” is an e-mail or other network address for the user that is associated with the user's account at platform 10.

At step 230, the user's account is created at platform 10 upon completion of the requisite user/platform 10 exchange, facilitated by computing device 20, described in connection with step 210. As part of platform 10 creating the user's account, platform 10 may also obtain information from address headers of information packets received from computing device 20.

After the user's account has been created at platform 10, at step 240, platform 10 initiates communication with any vendor(s) 40, 50, 60 from whom the user wishes to consummate a purchase transaction (e.g., at step 210). In particular, at step 240, platform 10 initiates the creation of a proxy account in the name of the user at vendor(s) 40, 50, 60 from whom the user wishes to consummate a purchase transaction (e.g., at step 210) by executing, for example, an account creation script. Generally, platform 10 will create a proxy account at a vendor 40, 50, 60 from whom the user makes a purchase. That is, platform 10 will not generally create a proxy account at a vendor from which the user browses, but does not purchase, a product. Such proxy accounts are created in a manner that is similar to that initiated by the user using computing device 20 to directly interact with vendors 40, 50, 60, except that platform 10 performs the processing and creates a proxy account for the user at each vendor 40, 50, 60 with whom the user consummates a purchase transaction. For example, using standard techniques, platform 10 may be programmed with knowledge of the protocol for account creation at each of vendors 40, 50, 60, and may interact with vendor(s) 40, 50, 60 on the basis of such knowledge to create a proxy account for one or more customers. In addition, such protocol information may generally be obtained from a vendor's 40, 50, 60 website, for example, by identifying the forms, and their corresponding fields and field names that a user would normally have to fill out to create an account at that vendor's website. This process may also be automated by using a script which that would automatically extract this information from the HTML (Hypertext Markup Language) of the relevant account creation page(s) on the vendor's site. Protocol information may also be obtained from Application Programming Interface (API) documentation for cases in which accounts are created via communications with a vendor using Extensible Markup Language (XML). Platform 10 stores the proxy account information for each user that has an account with platform 10 in storage for future access by platform 10.

At step 250, vendors 40, 50, 60 create a proxy account for the user in response to processing performed and communications transmitted and/or received by platform 10. A proxy account is an account created at one or more of vendors 40, 50, 60, that is used to facilitate purchase transactions on behalf of the user at the respective vendor(s) 40, 50, 60. Creation of a proxy account at a vendor 40, 50, 60 is transparent, or substantially transparent, to the user. A proxy account can be created, for example, when the user adds an item to his/her shopping cart, when the user wishes to checkout and make a purchase, or subsequent to when the user wishes to checkout and make a purchase. A proxy account can be created at a vendor 40, 50, 60 without the user checking out to purchase one or more items. At step 260, platform 10 transmits commands to each vendor 40, 50, 60 to log into the corresponding customer proxy accounts. In response, at step 270, each vendor 40, 50, 60 then logs platform 10 on to the corresponding user proxy account.

At step 280, platform 10 executes, for example, an add to basket script, causing each vendor 40, 50, 60 system to add the corresponding product(s) from the user's items requested for purchase (e.g., at step 210) on to that vendor system's shopping basket for the corresponding user proxy account. This can be accomplished by using, for example, the HTTP (Hypertext Transport Protocol) get and post methods. When a user clicks an add to basket button on a web page of a vendor 40, 50, 60, the get and post methods can be executed in accordance with the code at the vendor's 40, 50, 60 server in a way that results in populating the user's basket at the vendor's 40, 50, 60 website with the desired item(s). In one or more embodiments of the invention, the relevant get and post method information associated with the corresponding product would be stored in the platform 10 data repository, and submitted automatically on behalf of the user by platform 10.

At step 290, vendors 40, 50, 60 add the corresponding product(s) to the user's proxy account shopping basket, based on the platform 10 request. At step 295, platform 10 executes, for example, a purchase script for each vendor 40, 50, 60 to initiate purchase of the corresponding product(s) in the corresponding vendor 40, 50, 60 shopping basket. This is similarly accomplished through the HTTP get and post methods. When a user clicks a complete checkout button on a web page of a vendor 40, 50, 60, the get and post methods are executed in accordance with the code at the vendor's 40, 50, 60 server in a way that results in the user's purchase of the product(s) from the vendor's 40, 50, 60 website. In one or more embodiment of the invention, the relevant get and post method information associated with the corresponding shopping basket or checkout page would be stored in the platform 10 data repository and submitted automatically on behalf of the user by platform 10. In response, at step 298, each vendor 40, 50, 60 system completes the platform 10-driven transaction for a user.

Proxy Account Creation in Connection with Subsequent Purchases

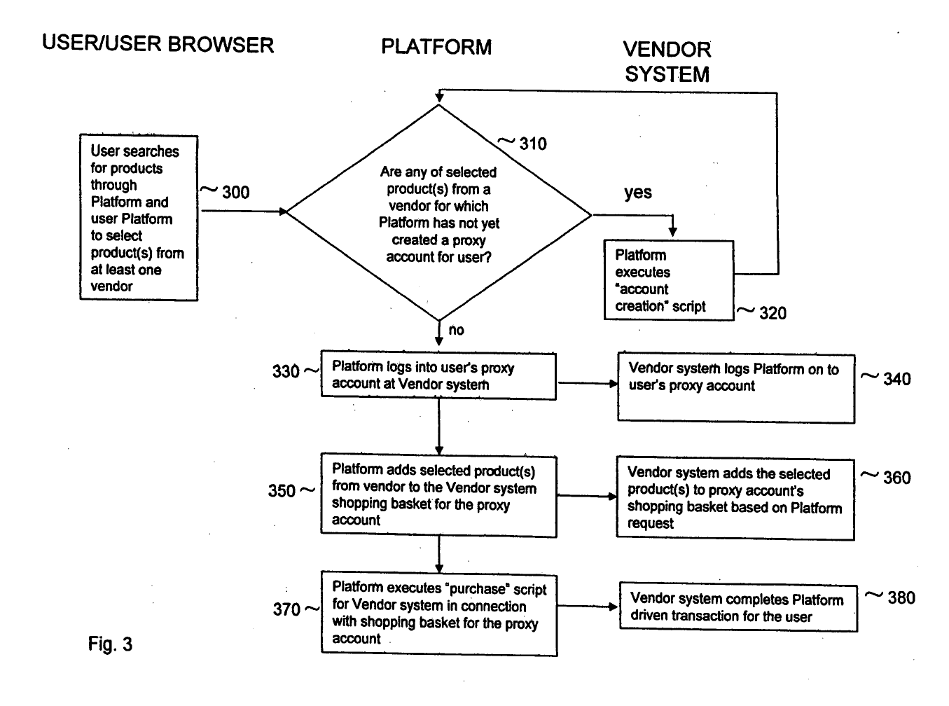

FIG. 3 is an exemplary flow diagram enabling a user to make subsequent purchases of one or more items from one or more vendors 40, 50, 60. As is shown in FIG. 3, processing begins in the same or similar manner as that of the embodiment of FIG. 2 (in connection with a first-time purchase by a user using computing device 20 to communicate with platform 10), with the user at step 300 interacting with platform 10 to search for one or more product(s) of one or more vendors 40, 50, 60, and selecting one or more products for purchase.

At decision step 310, platform 10 determines whether any vendor(s) 40, 50, 60 selected by the user at computing device 20 for purchase of product(s) is one for which platform 10 had not previously created a proxy account for the customer. If platform 10 determines that the user at computing device 20 is purchasing from a vendor 40, 50, 60 for which it has not already created a proxy account, platform 10, at step 320, executes an account creation script as described above in connection with FIG. 2 to create a proxy account for the user at that vendor 40, 50, 60. Platform 10 stores the corresponding proxy account information for the user in storage for access by platform 10.

If platform 10 determines that the user already has a proxy account for each vendor 40, 50, 60 selected by the user, then, platform 10 at step 330, initiates the process of logging into the user's proxy account at each vendor 40, 50, 60. At step 340, upon receiving the corresponding commands from platform 10, each of the vendor systems 40, 50, 60 logs platform 10 into the user's corresponding proxy account. Once logged into the vendor 40, 50, 60 system(s), platform 10, at step 350, executes, for example, an add to basket script (as previously described) to add the product(s) selected for purchase from that vendor 40, 50, 60 (consistent with the user's selection at step 300) on to that vendor system's shopping basket for the user's proxy account. In response to these communications by platform 10, each vendor 40, 50, 60 system at step 360 adds the corresponding selected product(s) to the user's proxy account shopping basket.

At step 370, platform 10 executes, for example, a purchase script (as previously described) for each vendor 40, 50, 60 system in connection with the shopping basket for the proxy account for that respective vendor 40, 50, 60 system. In response to these communications by platform 10, the vendor 40, 50, 60 system at step 380 completes the platform 10-driven transaction(s) on behalf of the user.

Platform 10 can execute one or more scripts to complete a task automatically for a customer on a vendor 40, 50, 60 site. The determination of which scripts may be executed may be based, for example, on vendor 40, 50, 50 specific protocols and/or unique form elements for a given task in platform 10's database. The script(s) may be created and loaded onto platform 10 for execution by a platform developer, based, for example, on the relevant tasks to be executed at the vendor 40, 50, 60 site and/or the vendor code corresponding to task. Once the script relevant to the task is called, platform 10 can use, for example, the HTTP get and post methods to transmit information on behalf of the user from computing device 20 to the vendor(s) 40, 50, 60 to complete tasks such as account creation, add to cart, update and/or purchase item(s). Platform 10 can develop new and/or modify existing scripts to create a custom script adapted to a vendor's 40, 50, 60 protocols and form elements. For example, a pre-programmed process examining vendor 40, 50, 60 protocols and form elements can be utilized to search for this information and extract it using regular expressions from the vendor's 40, 50, 60 HTML.

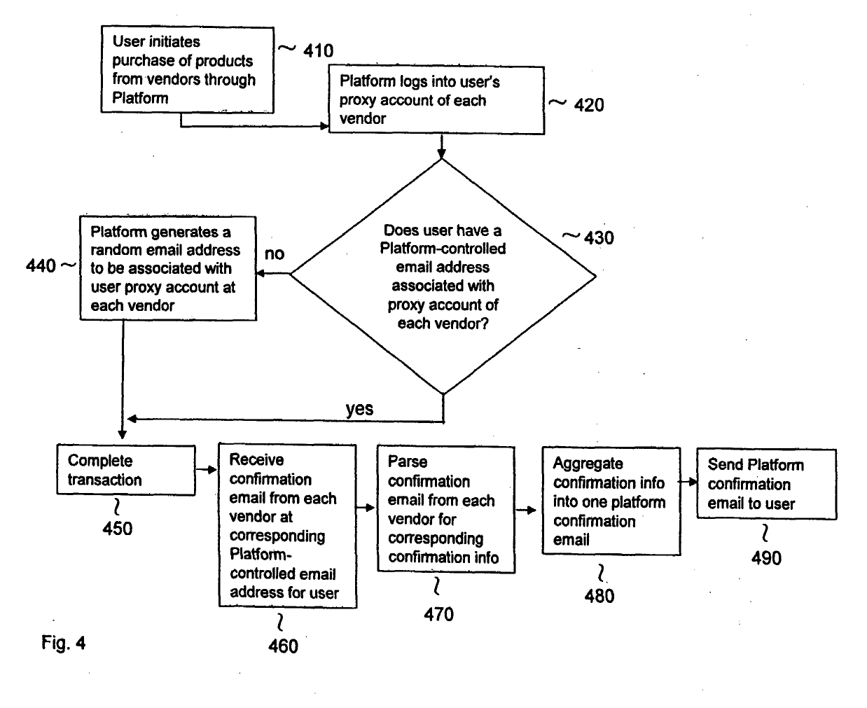

FIG. 4 is an exemplary flow diagram for aggregating confirmation e-mails from one or more vendors into a single e-mail to be transmitted to the user. In one or more embodiments of the present invention, platform 10, after performing purchases on behalf of a user, aggregates and formats the confirmation e-mails received from each of the vendors 40, 50, 60 in connection with the corresponding purchase, and transmits a single confirmation e-mail to computing device 20 that can be viewed by the user.

Platform 10, during or in connection with creating an account at platform 10 for the user (e.g., step 220 and 230 of FIG. 2), can create a randomly generated e-mail address on behalf of the user. The new email address can be created by using either a standard e-mail service provider (e.g., Yahoo.com), or by platform 10. In particular, platform 10 may execute, for example, a standard script that automatically creates an e-mail address. The randomly generated e-mail address need not be linked with the user at computing device 20 or any information supplied by the user when creating an account. An e-mail address provided at any domain accessible by platform 10 will suffice, provided it has not already been taken by another user. Platform 10 stores information corresponding to particular users with the respective randomly generated e-mail addresses. Platform 10 may thus retrieve the randomly generated e-mail address for a user based on the user's platform 10 account, or vice versa.

More particularly, at step 410, the user at computing device 20 initiates the purchase of one or more products from each of one or more vendors 40, 50, 60 through platform 10 as discussed, for example, in connection with FIGS. 2 and/or 3. At step 420, platform 10 logs into the user's proxy accounts at each of vendors 40, 50, 60.

If, at decision step 430, it is determined that the user does not have an e-mail account with one or more vendors 40, 50, 60 from whom the user wishes to purchase a product, then, at step 440, platform 10 generates a random e-mail address that is associated with each vendor 40, 50, 60 for whom the user does not have an e-mail account, and associates the e-mail account with the user's proxy account for that particular vendor 40, 50, 60. Alternatively, if, at decision step 430, it is determined that the user does have an e-mail account associated with each vendor 40, 50, 60 from whom the user wishes to purchase a product, then, at step 450, platform 10 completes the transaction requested at step 410 by the user by executing, for example, add to cart and purchase scripts for each of the selected vendors 40, 50, 60 using the proxy accounts for the customer at those vendors 40, 50, 60. Because each proxy account for the user at each vendor 40, 50, 60 contains information relating to a platform 10-controlled randomly generated e-mail address, platform 10, at step 460, is able to receive and retrieve the transaction confirmation e-mail messages sent by each selected vendor 40, 50, 60 to the respective e-mail addresses when the transactions are complete.

At decision step 430, platform 10, in one or more embodiments of the present invention, may determine whether the user's randomly generated e-mail address has already been registered with each vendor 40, 50, 60 respectively associated with each of the user's product purchases selected, for example, in conjunction with step 210. Platform 10 may determine whether the user has an e-mail address associated with each vendor 40, 50, 60 from which a product is desired to be purchased simply by having previously stored such e-mail account information in a memory (not shown) of platform 10, and checking for such e-mail account information, for example, at the time of purchase of the products.

At step 470, a confirmation e-mail engine (not shown) associated with platform 10 parses the confirmation e-mails retrieved from the platform 10-controlled e-mail addresses for selected information to be included in a single platform 10-generated confirmation e-mail message for the transaction. The parsing of relevant information from confirmation e-mails is performed, for example, by applying a series of regular expressions, written by a platform developer or by utilizing an automated regular expression generating script, to extract relevant order information from each standard confirmation e-mail's text or HTML from each vendor 40, 50, 60. Alternatively, an automated script can search for key words associated with relevant order information and apply a regular expression to extract the string associated with the located search term in the text or HTML.

For example, if an e-mail address always followed the string “e-mail:”, the text and/or HTML would be searched for the “e-mail:” string and the string immediately following it would be extracted through the use of a regular expression and recorded as the relevant e-mail address associated with the order in the platform 10 database. Furthermore, if an order table was displayed and the first column read “Product Name”, the script would extract or parse all strings in the product name column and store them as different product names in the platform's database. Either of the two above standard methods, as well as other known techniques, may be used to parse relevant data from the confirmation e-mail. The selected information may include information identifying the purchased products (e.g., names of or codes corresponding to the products), purchase prices, taxes, shipping costs, total costs, estimated delivery time, order tracking numbers, customer service information and/or return information.

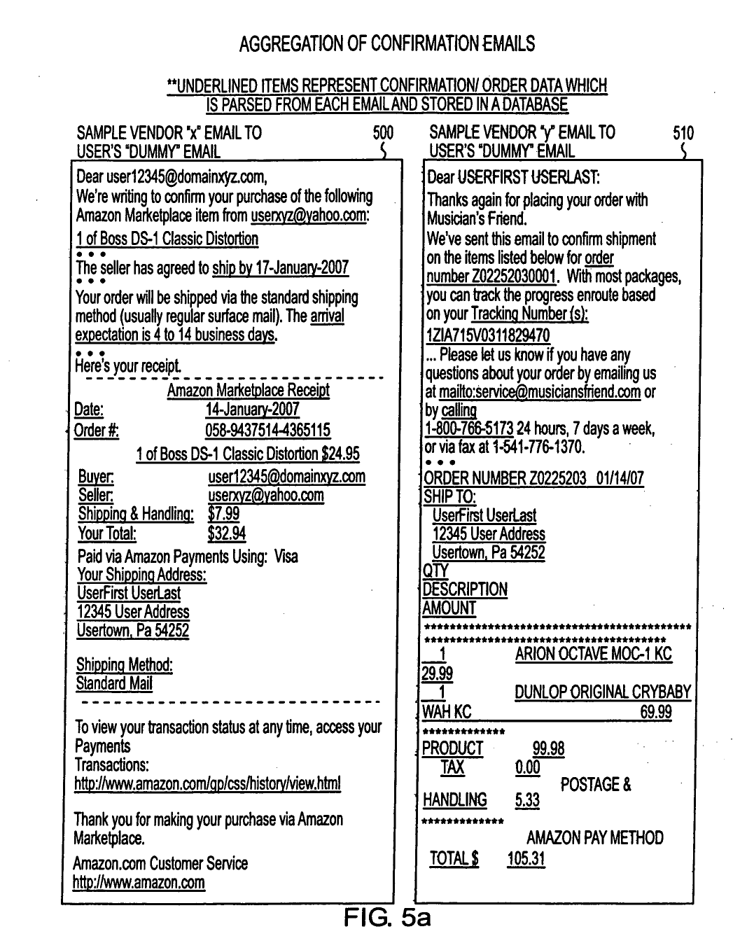

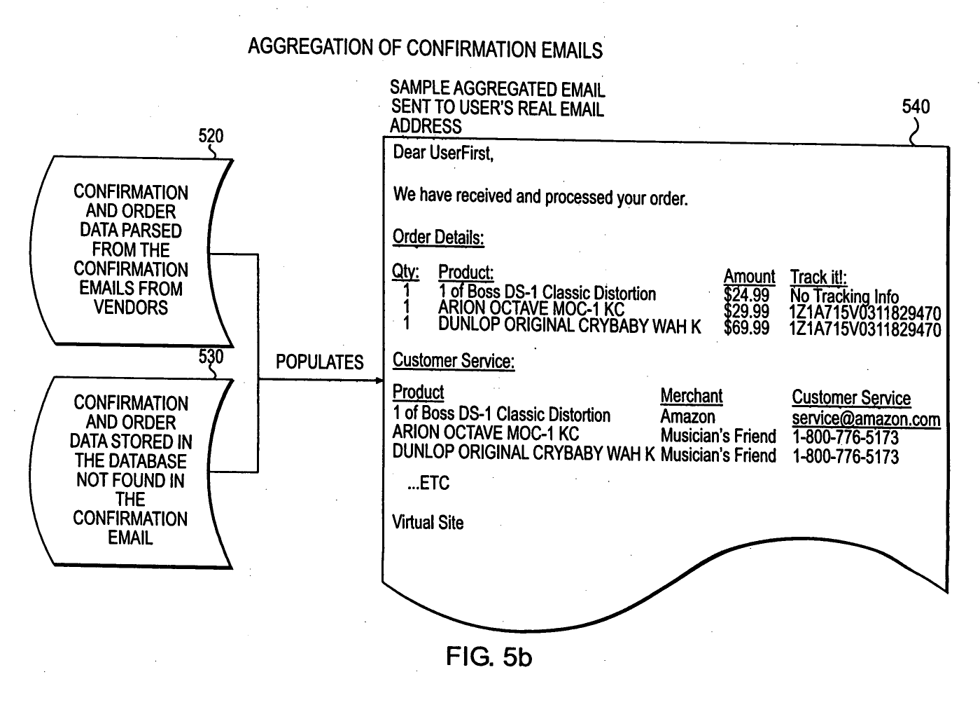

At step 480, platform 10 aggregates information parsed from the confirmation e-mails received from the selected vendors in step 470, and generates a single e-mail for mailing to the customer's “usual” or “real” e-mail account (i.e., the operational e-mail address), which, in one or more embodiments of the present invention, may have been requested and obtained from the user during the user's registration with platform 10, for example, in connection with step 220. This process is further illustrated in FIGS. 5a and 5b. Confirmation information from the set of vendors 40, 50, 60 from which the user using computing device 20 purchased products through platform 10 in a single transaction is aggregated into a single platform 10 confirmation e-mail message, which may be supplemented with information in platform 10's database that is associated with the user. Finally, at step 490, platform 10 transmits the aggregated platform confirmation e-mail message to the user's real e-mail address that is stored, for example, in platform 10's data repository.

Rather than obtaining or generating a unique randomly generated e-mail address for user 10 with each vendor 40, 50, 60 with which the user engages in transactions through platform 10, platform 10 may also prompt the user, who is using computing device 20, for a preexisting e-mail address and corresponding login information for use as a proxy e-mail address. Using computing device 20, the user may independently access the e-mail address that platform 10 uses for receiving confirmation e-mail messages from vendors 40, 50, 60 with which platform 10 engages in and/or completes transactions on the user's behalf. Each e-mail address that platform 10 associates with the user may be registered with the customer at any number of vendors 40, 50, 60.

FIGS. 5a and 5b, taken together, further illustrate aspects of the confirmation e-mail 500 aggregation process. FIG. 5a shows a first e-mail 500 from a first vendor and a second e-mail 510 from a second vendor. E-mail 500 illustrates the purchase of “1 of Boss DS-1 Classic Distortion.” E-mail 510 illustrates the purchase of “ARION OCTAVE MOC-1 KC” and “DUNLOP ORIGINAL CRYBABY”. The underlined data (e.g., Date of 14-January-2007, Buyer:, Seller:, DESCRIPTION, AMOUNT, etc.) is confirmation order data that is parsed from each e-mail 500, 510 and stored in a data repository associated with platform 10. This data is primarily related to the contents and status of the user's order, but may also include information pertaining to warranty, return and/or customer service.

FIG. 5b illustrates the aggregation by platform 10 of information in each of e-mails 500, 510 into a single e-mail 540. More particularly, element 520 illustrates the confirmation and order data that is parsed from the confirmation e-mails 500, 510 from the two different vendors (e.g., vendors 40 and 50). Element 530 illustrates the confirmation and order data stored in platform 10's data repository that was not found in a confirmation e-mail 500, 510. Examples of data stored in platform 10's data repository which may not be found in the information parsed from the confirmation e-mail messages 500, 510 from vendors 40, 50 may include platform 10-specific information such as a standard or customized greeting, an order message, a set of customer service information, return information, and/or product/order information. This information is not supplied by the vendors 40, 50 in their confirmation e-mail messages 500, 510. As is illustrated in FIG. 5b, at least portions of the information from elements 520 and 530 are combined to form e-mail message 540, which is transmitted by platform 10 to the customer's real e-mail address.

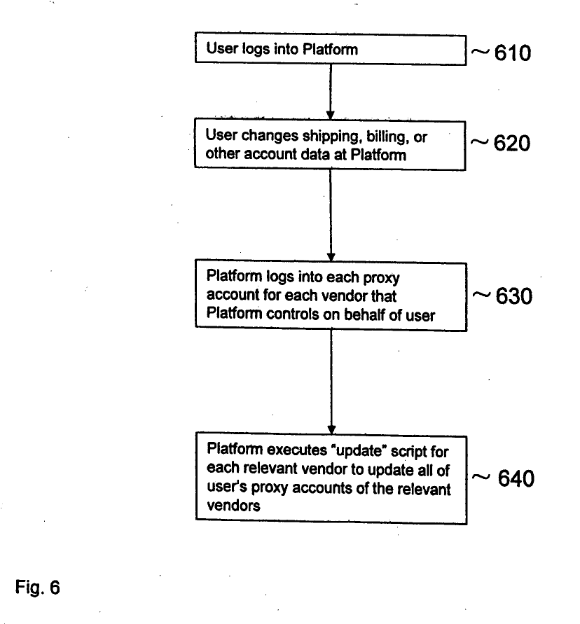

FIG. 6 is an exemplary flow diagram enabling user account information to be automatically updated in the user's proxy account at one or more vendors 40, 50, 60. In the embodiment illustrated in FIG. 6, platform 10 automatically updates the user's information at each of the user proxy accounts after the user, using computing device 20, modifies his account information associated with platform 10.

At step 610, the user, using computing device 20, logs into his platform 10 account. At step 620, the user accesses his platform 10 account setting and changes at least a portion or one or more fields of his account information. For example, the user can change his shipping information,.billing information and/or other relevant data that is part of the user's platform 10 account. At step 630, platform 10 logs into each proxy account for each vendor 40, 50, 60 that platform 10 controls on behalf of the user. At step 640, platform 10 executes an update script for each of the vendors 40, 50, 60 to update each of the user's proxy accounts at these vendors 40, 50, 60. The update script submits the relevant user information associated with the user's proxy account. In one embodiment, the user information can be transmitted automatically from platform 10 to vendors 40, 50, 60, using the HTTP get and post methods.

Platform 10 interacts with both the user and vendors 40, 50, 60 by transmitting messages or commands through network 30. These messages or commands may include actual commands or may include information representing actual commands. Further, such messages or commands may include data required or needed by the recipient (e.g., platform 10) to carry out the commands, or take the action set forth in the messages. Terms such as “instruction” or “indication” may denote any one or all of these possibilities.

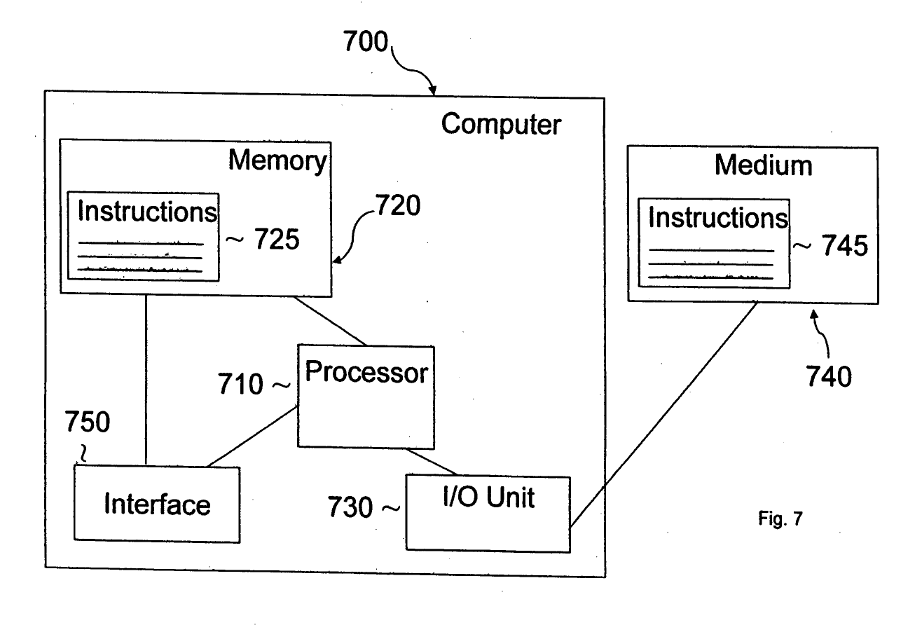

Other aspects of the invention are made apparent based on this disclosure, including systems and computer-readable media capable of performing various aspects of the invention. For example, FIG. 7 shows an exemplary computer-apparatus and storage-medium embodiment of the invention.

In FIG. 7, medium 740 contains instructions 745 that may be operatively coupled to computer 700. For example, instructions 745 may include instructions corresponding to aspects of various embodiments of the invention described in connection, for example, with FIGS. 2-4. Computer 700 contains processor 710, which is operably connected to input/output unit 730 and memory 720. Computer 700 also has interface 750 that provides connectivity to one or more networks, such as network 30 of FIG. 1. Memory 720 may also include instructions 725 that implement aspects of the functionality of one or more embodiments of the invention as described, for example, in connection with FIGS. 2-4.

Propagating signals embodied in a medium, such as a carrier wave or other carrier medium, that are products of embodiments of methods of the invention, or products of the use of embodiments of systems or devices of the present invention, are within the scope and spirit of the present invention and the appended claims.

The structures shown and discussed in embodiments of the invention are exemplary only and the functions performed by these structures may be performed by any number of structures. For example, certain functions may be performed by a single physical unit, or may be allocated across any number of different physical units. All such possible variations are within the scope and spirit of embodiments of the invention and the appended claims.

Embodiments of the present invention have been described for the purpose of illustration. Persons skilled in the art will recognize from this description that the described embodiments are not limiting, and may be practiced with modifications and alterations limited only by the spirit and scope of the appended claims which are intended to cover such modifications and alterations, so as to afford broad protection to the various embodiments of invention and their equivalents.

Having thus described my invention, what I claim as new and desire to secure by Letters Patent is as follows:

1. A method for facilitating the purchase of items from multiple vendors on a network through a platform, comprising:
receiving at the platform a request from a user for purchase of at least one item from at least one vendor;
transmitting, from the platform, instructions to create a user account at least one vendor;
transmitting, from the platform, an indication to each of the at least one vendor to purchase at least one item through the corresponding user account; and
receiving at the platform a corresponding confirmation associated with the user account at each of the at least one vendor.

2. The method of claim 1 further comprising creating a platform account for the user.

3. The method of claim 2 wherein the transmitting instructions to create a user account is based on stored user information associated with the platform account.

4. The method of claim 3 wherein the transmitting instructions to create the user account is further based on information obtained from the user after transmitting the indication to at least one vendor.

5. A method in accordance with claims 1 or 2 further comprising, after transmitting the instructions, logging in to each of the corresponding user accounts.

6. The method of claim 2 further comprising:
receiving account update information from the user;
updating the platform account for the user based on the account update information; and
transmitting corresponding user account update instructions to at least one vendor.

7. The method of claim 1 wherein each corresponding confirmation is received at a corresponding e-mail account that is created by the platform and associated with each corresponding user account.

8. The method of claim 7 wherein each corresponding e-mail account is created in response to receiving the request from the user for purchase of at least one item from at least one vendor.

9. The method of claim 8 wherein transmitting the instructions to create a user account comprises transmitting an address for each corresponding e-mail account to each of the at least one vendor.

10. The method of claim 7 further comprising transmitting a platform confirmation e-mail message to an operational e-mail address of the user, wherein the platform confirmation e-mail is based on the corresponding confirmation from each of the at least one vendor.

11. The method of claim 10 wherein the platform confirmation e-mail is further based on user information associated with the platform account stored in memory.

12. A method for facilitating the purchase of items from multiple vendors on a network, comprising:
receiving a request from a user for purchase of a first item from a first vendor, and a second item from a second vendor;
transmitting a first instruction to create a first user account at the first vendor;
transmitting a second instruction to create a second user account at the second vendor;
transmitting a first purchase indication to the first vendor for purchase of the first item through the first user account;
transmitting a second purchase indication to the second vendor for purchase of the second item through the second user account;
receiving a first purchase confirmation from the first vendor; and
receiving a second purchase confirmation from the second vendor.

13. The method of claim 12 further comprising creating a platform account for the user.

14. The method of claim 13 further comprising:
receiving at the platform account update information from the user;
updating the platform account for the user based on the account update information;
transmitting a first update instruction based on the account update information to the first vendor; and
transmitting a second update instruction based on the account update information to the second vendor.

15. The method of claim 13 wherein the first instruction includes a first proxy e-mail address associated with the platform account for the user, and the second instruction includes a second proxy e-mail address associated with the platform account for the user.

16. The method of claim 15 wherein the first confirmation is received by the first proxy e-mail address, and the second confirmation is received by the second proxy e-mail address.

17. The method of claim 16 further comprising the platform accessing the first confirmation and the second confirmation.

18. The method of claim 17 wherein the platform account associates an operational e-mail address with the user.

19. The method of claim 18 further comprising transmitting from the platform a confirmation e-mail message to the operational e-mail address, wherein the platform confirmation e-mail is based on the first confirmation and the second confirmation.

20. The method of claim 16 wherein the first proxy e-mail address and the second proxy e-mail address are the same.

21. The method of claim 16 wherein the first proxy e-mail address and the second proxy e-mail address are different.

22. A system for facilitating the purchase of items from multiple vendors on a network, comprising:
a computing device for receiving a request from a user for purchase of a first item from a first vendor and a second item from a second vendor, the computing device transmitting a first instruction to create a first user account on behalf of the user at the first vendor and transmitting a second instruction to create a second user account on behalf of the user at the second vendor, the computing device further transmitting a first purchase indication to the first vendor for purchase of the first item through the first user account and transmitting a second purchase indication to the second vendor for purchase of the second item through the second user account, the computing device further receiving a first confirmation from the first vendor and receiving a second confirmation from the second vendor.

23. The system of claim 22 wherein the computing device creates a platform account for the user.

24. The system of claim 23 wherein the computing device further:
receives account update information from the user;
updates the platform account for the user based on the account update information;
transmits a first update instruction based on the account update information to the first vendor; and
transmits a second update instruction based on the account update information to the second vendor.

25. The system of claim 23 wherein the first instruction includes a first proxy e-mail address associated with the platform account for the user, and the second instruction includes a second proxy e-mail address associated with the platform account for the user.

26. The system of claim 25 wherein the first confirmation is received by the first proxy e-mail address, and the second confirmation is received by the second proxy e-mail address.

27. The system of claim 26 wherein the computing device accesses each of the first confirmation and the second confirmation using the first proxy e-mail address and second proxy e-mail address, respectively.

28. The system of claim 27 wherein the platform account associates an operational e-mail address with the user.

29. The system of claim 28, wherein the computing device transmits a platform confirmation e-mail message to the operational e-mail address, and the platform confirmation e-mail is based on the first confirmation and the second confirmation.

30. The system of claim 25, wherein the first proxy e-mail address and the second proxy e-mail address are the same.

31. The system of claim 25 wherein the first proxy e-mail address and the second proxy e-mail address are different.

32. A computer program product residing on a computer readable medium, for use in a computer network environment that facilitates the purchase of items from multiple vendors on a network, the computer program product comprising instructions for causing a computer to:
receive a request from a user for purchase of a first item from a first vendor, and a second item from a second vendor;
transmit a first instruction to create a first user account at the first vendor;
transmit a second instruction to create a second user account at the second vendor;
transmit a first purchase indication to the first vendor for purchase of the first item through the first user account;
transmit a second purchase indication to the second vendor for purchase of the second item through the second user account;
receive a first purchase confirmation from the first vendor; and
receive a second purchase confirmation from the second vendor.

33. The computer program product of claim 32 further comprising instructions for causing a computer to create a platform account for the user.

34. The computer program product of claim 33 further comprising instructions for causing a computer to:
receive account update information from the user;
update the platform account for the user based on the account update information;
transmit a first update instruction based on the account update information to the first vendor; and
transmit a second update instruction based on the account update information to the second vendor.

35. The computer program product of claim 33 further comprising instructions for causing a computer to associate a first proxy e-mail address with the platform account for the user, and associate a second proxy e-mail address with the platform account for the user.

36. The computer program product of claim 35 further comprising instructions for causing a computer to access each of the first confirmation and the second confirmation using the first proxy e-mail address and second proxy e-mail address, respectively.

37. The computer program product of claim 36 further comprising instructions for causing a computer to enable the platform account to transmit to an operational e-mail address associated with the user.

38. The computer program product of claim 37 further comprising instructions for causing a computer to transmit a platform confirmation e-mail message to the operational e-mail address based on the first confirmation and the second confirmation.

39. A modulated data signal carrying computer executable instructions for performing the method of claim 1.
